(19) United States
(12) Patent Application Publication
(10) Pub. No.: US 2017/0316712 A1
(43) Pub. Date: Nov. 2, 2017

(54) Aircraft Procedural Trainer Interface

(71) Applicant: Bell Helicopter Textron, Inc., Fort Worth, TX (US)

(72) Inventors: Steven Wayne Kihara, North Richland Hills, TX (US); Jeremy Robert Chavez, Colleyville, TX (US)

(73) Assignee: Bell Helicopter Textron, Inc., Fort Worth, TX (US)

(21) Appl. No.: 15/375,292

(22) Filed: Dec. 12, 2016

Related U.S. Application Data
(60) Provisional application No. 62/328,573, filed on Apr. 27, 2016.

(51) Int. Cl. G09B 9/08; G09B 9/32; G09B 9/30; G09B 9/24; G09B 9/22; G09B 9/46; G09B 9/00

(52) U.S. Cl. CPC G09B 9/08; G09B 9/46; G09B 9/32; G09B 9/003; G09B 9/24; G09B 9/22; G09B 9/30

(57) ABSTRACT

A control and simulation system (CSS) has a flight system configured to selectively provide flight mode of operation of an aircraft and a simulation system configured to selectively provide a simulation mode of operating the aircraft.

### CROSS-REFERENCE TO RELATED APPLICATIONS

This patent application claims the benefit of the filing date of the U.S. Provisional Patent Application Ser. No. 62/328,573, filed on 27 Apr. 2016 and entitled “Aircraft Procedural Trainer Interface,” the entire content of which is hereby expressly incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Many vehicle training systems exist as standalone devices that emulate physically and/or virtually the environment and/or operations of the vehicles for which they are designed to provide training. However, the physical interfaces and/or simulated vehicle behavior is often not fully accurate relative to the actual vehicle, sometimes leading to training failures and/or training inefficiencies. In some cases, such as, but not limited to, military operations where vehicle operators are deployed away from traditional training facilities that house the vehicle training systems, vehicle training systems may be transported to the location of the deployed vehicle operators to allow vehicle operators training opportunities while deployed. However, such transportation of vehicle training systems is expensive and logistically limiting.

### BRIEF DESCRIPTION OF THE DRAWINGS

FIG. 1 is an oblique view of a tiltrotor aircraft according to an embodiment of this disclosure showing the tiltrotor aircraft in a helicopter mode of operation and in a training/simulation mode of operation, the tiltrotor aircraft comprising a control and simulation system (CSS).

FIG. 2 is an oblique view of the tiltrotor aircraft of FIG. 1 showing the tiltrotor aircraft in an airplane mode of operation.

FIG. 3 is a partial oblique view of the tiltrotor aircraft of FIG. 1 shown comprising a CSS within a cockpit.

FIG. 4 is a schematic view of the CSS of FIG. 1.

FIG. 5 is a flow chart of a method of operating the tiltrotor aircraft of FIG. 1.

FIG. 6 is a schematic view of an alternative embodiment of a CSS.

FIG. 7 is a simplified representation of a general-purpose processor (e.g. electronic controller or computer) system suitable for implementing the embodiments of the disclosure.

### DETAILED DESCRIPTION

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

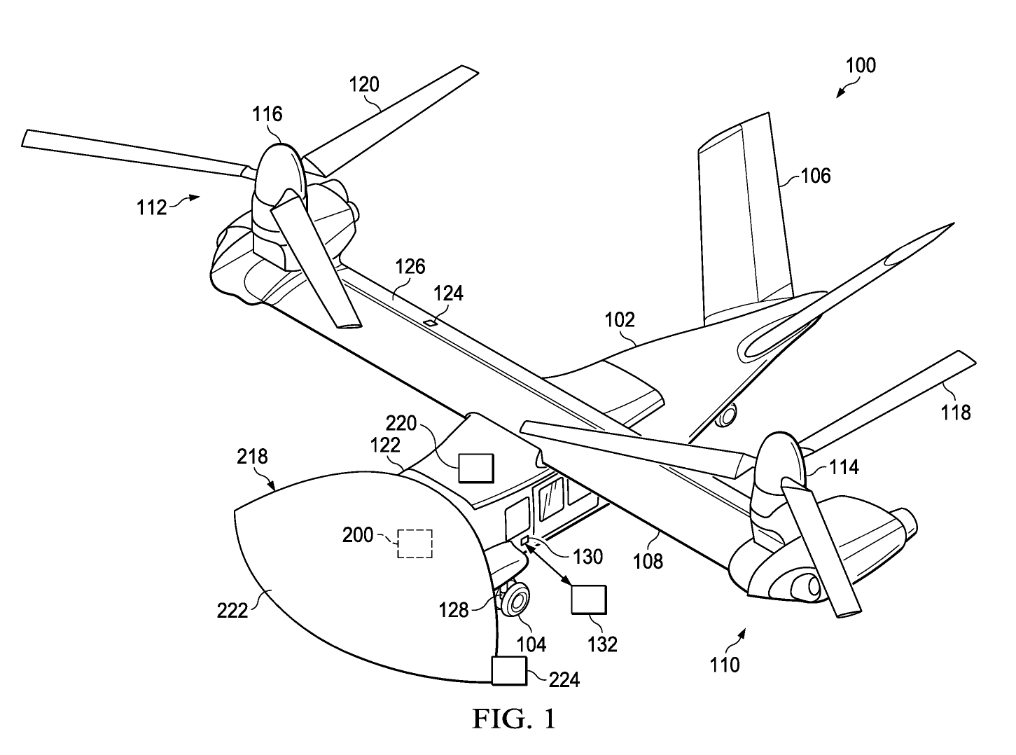

Referring to FIG. 1 in the drawings, a tiltrotor aircraft 100 is illustrated. Tiltrotor aircraft 100 can include a fuselage 102, a landing gear 104, a tail member 106, a wing 108, a propulsion system 110, and a propulsion system 112. Each propulsion system 110 and 112 includes a fixed engine and a rotatable proprotor 114 and 116, respectively. Each rotatable proprotor 114 and 116 have a plurality of rotor blades 118 and 120, respectively, associated therewith. The position of proprotors 114 and 116, as well as the pitch of rotor blades 118 and 120, can be selectively controlled in order to selectively control direction, thrust, and lift of tiltrotor aircraft 100.

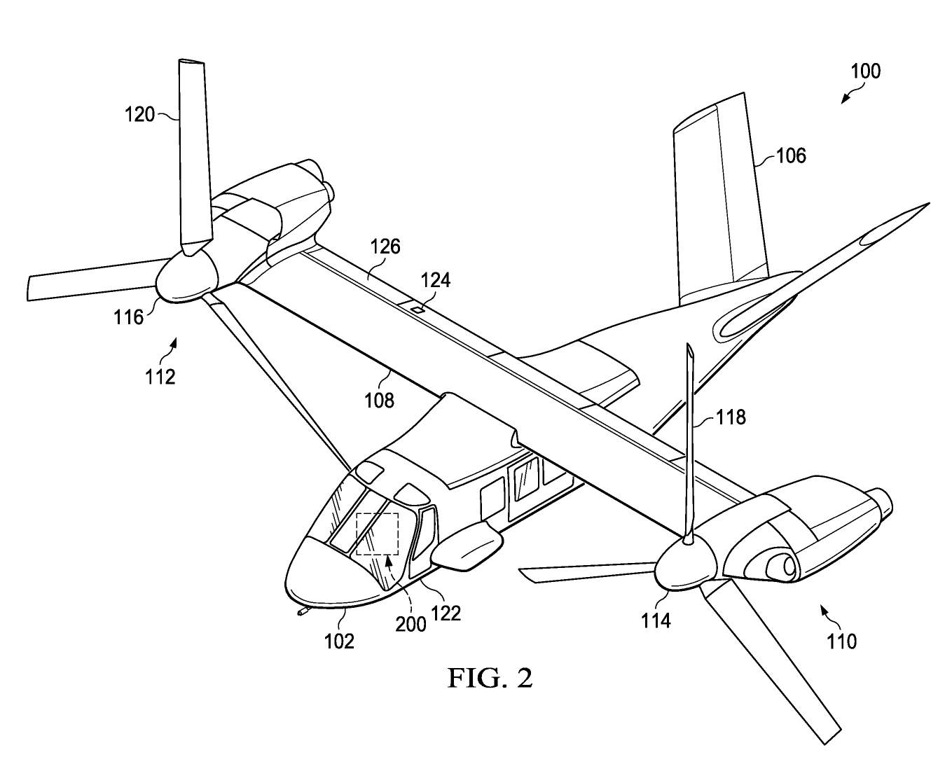

FIG. 1 illustrates tiltrotor aircraft 100 in a grounded helicopter mode, in which proprotors 114 and 116 are positioned substantially vertical to provide a lifting thrust. FIG. 2 illustrates tiltrotor aircraft 100 in an airplane mode, in which proprotors 114 and 116 are positioned substantially horizontal to provide a forward thrust in which a lifting force is supplied by wing 108. It should be appreciated that tiltrotor aircraft can be operated such that proprotors 114 and 116 are selectively positioned between airplane mode and helicopter mode, which can be referred to as a conversion mode.

The propulsion system 112 is substantially symmetric to the propulsion system 110; therefore, for sake of efficiency certain features will be disclosed only with regard to propulsion system 110. However, one of ordinary skill in the art would fully appreciate an understanding of propulsion system 112 based upon the disclosure herein of propulsion system 110.

Further, propulsion systems 110 and 112 are illustrated in the context of tiltrotor aircraft 100; however, propulsion systems 110 and 112 can be implemented on other tiltrotor aircraft. For example, an alternative embodiment may include a quad tiltrotor that has an additional wing member aft of wing 108, the additional wing member can have additional propulsion systems similar to propulsion systems 110 and 112. In another embodiment, propulsion systems 110 and 112 can be used with an unmanned version of tiltrotor aircraft 100. Further, propulsion systems 110 and 112 can be integrated into a variety of tiltrotor aircraft configurations. The tiltrotor aircraft 100 further comprises a control and simulation system (CSS) 200 described in greater detail below.

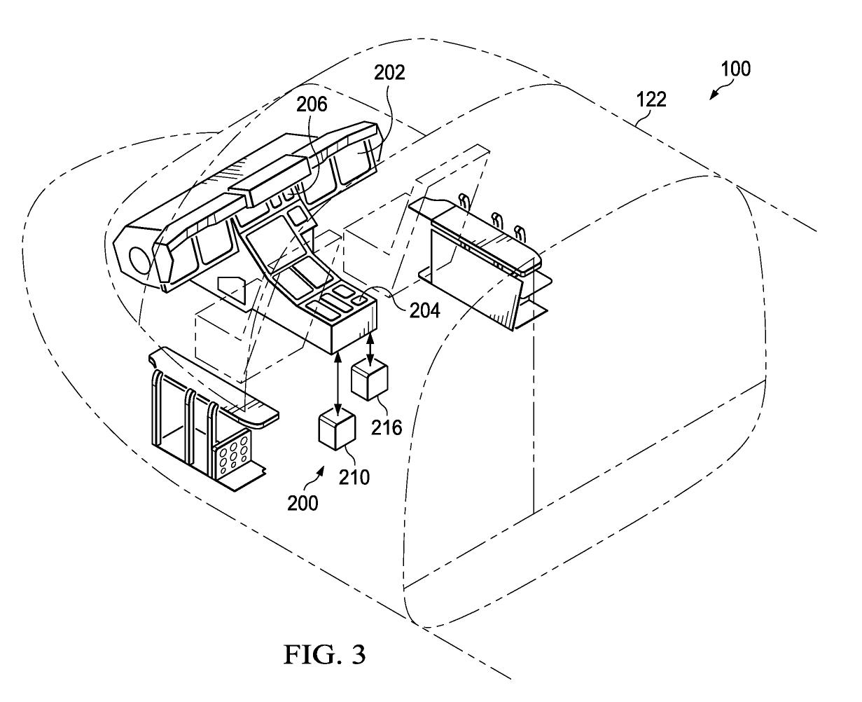

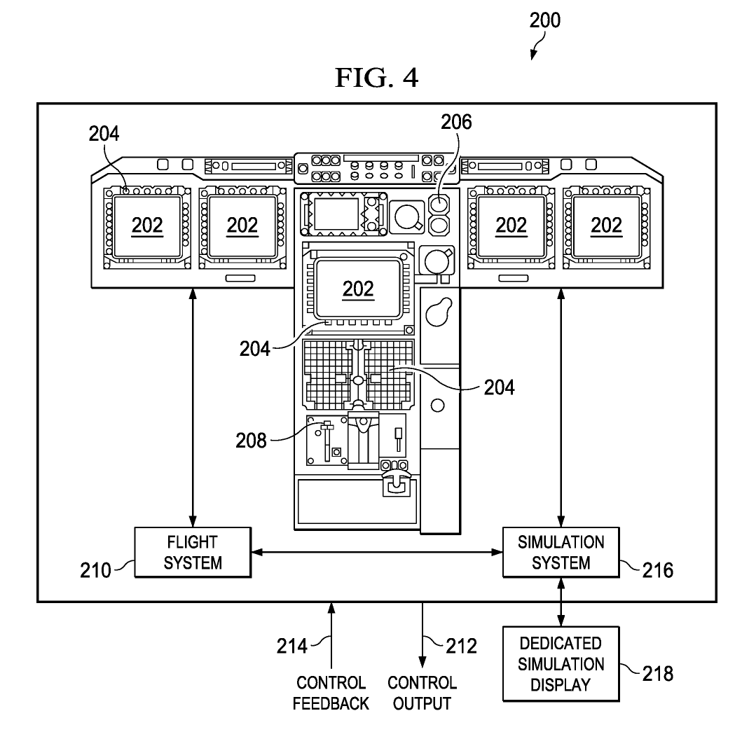

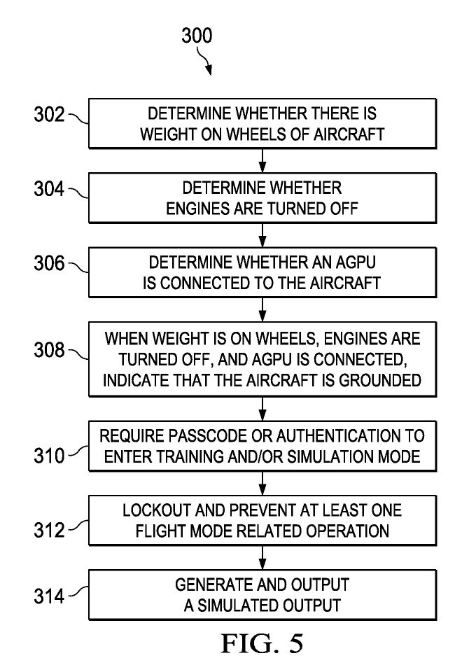

Referring now to FIGS. 3 and 4, a CSS 200 is shown disposed in a cockpit 122 of the tiltrotor aircraft 100 and schematically represented, respectively. The CSS 200 generally comprises displays 202, input devices 204, instruments 206, and controls 208 configured to interact with a flight system 210 to control the tiltrotor aircraft 100. The CSS 200 is further configured to send control outputs 212 to the many physical and information systems of the tiltrotor aircraft 100, such as, but not limited to, actuators 124 and other components that affect physical operation of the tiltrotor aircraft 100. In this example, the actuators 124 are associated with movable flaps 126 of wing 108. The CSS 200 is further configured to receive control feedback 214 from the many physical and information systems of the tiltrotor aircraft 100, such as, but not limited to, actuators 124, weight on wheels sensors 128 associated with landing gear 104, auxiliary power sensors 130 associated with an auxiliary ground power unit 132 (AGPU), and other components that can provide feedback regarding the physical operation, location, and/or condition of the tiltrotor aircraft 100. Most generally, the above described components of the CSS 200 can be utilized in an automated and/or user managed manner to control the tiltrotor aircraft 100 in normal operation of the tiltrotor aircraft 100, such as aircraft flight.

CSS 200 further comprises a simulation system 216 that, when enabled, operates to provide procedural training, flight training, weapons system training, mission training, and/or any other suitable training utilizing the other already existing components of the tiltrotor aircraft 100, and optionally some additional components. In some embodiments, the simulation system 216 can communicate with the flight system 210 to exchange data and/or to share a computing burden. Each of the flight system 210 and the simulation system 216 can, in some embodiments, utilize the displays 202, input devices 204, instruments 206, and controls 208 as well as the control output 212 and the control feedback 214. However, unlike the flight system 210, the simulation system 216 provides little or no capability to physically alter operation of the tiltrotor aircraft 100. For example, the simulation system 216 may not be capable of starting and/or powering the engines of the tiltrotor aircraft 100. Most generally, the simulation system 216 is configured to provide procedural training insofar as when the simulation system 216 is operating, the displays 202, input devices 204, instruments 206, and controls 208 as well as the control output 212 and the control feedback 214 can be utilized to emulate actual flight-like operation of the aircraft so that a user utilizing the CSS 200 can learn procedural cockpit tasks in the exact environment the user may later actually operate the tiltrotor aircraft 100 using the flight system 210. In this manner, a tiltrotor aircraft 100 equipped with a CSS 200 can be utilized as both an operational aircraft and as a full fidelity trainer. In some embodiments, the simulation system 216 may be limited to providing only procedural training that utilizes the otherwise already existing componentry of the tiltrotor aircraft 100. However, in alternative embodiments, the simulation system 216 can be configured to further generate and output simulated flight video to a dedicated simulation display 218. As shown in FIG. 1, the dedicated simulation display 218 can comprise an optical projector 220 and a projector screen such as an inflatable partial dome screen 222 inflated by a pump 224. In some embodiments, the screen 222 can be positioned outside the tiltrotor aircraft 100 wind screens so that video projected onto the screen 222 can emulate environmental conditions such as landscape, weather, civil structures, incoming weapons fire, and/or any other suitable visually representable feature that may be useful in a training scenario. Still further, the CSS 200 can be configured to output sounds representative of training scenario acoustics.

In some embodiments, the CSS 200 can be controlled and switched between a flight mode and a simulation mode according to the method 300 described below. The method 300 can begin at block 302 by the CSS 200 first determining whether the tiltrotor aircraft 100 is on the ground by polling the status of the weight on wheels sensor 128 to determine whether there is weight on the wheels of the landing gear 104. If there is an indication that there is weight on the wheels, the method 300 can progress to block 304. At block 304, the CSS 200 may determine whether the engines of the tiltrotor aircraft 100 are turned off. If there is an indication that the engines are turned off, the method 300 can progress to block 306. At block 306, the CSS 200 may determine whether the AGPU 132 is connected to the tiltrotor aircraft 100 by polling the status of the auxiliary power sensor 130. If there is an indication that the AGPU 132 is connected to the tiltrotor aircraft 100, the method 300 may progress to block 308. At block 308, the method 300 may provide a visual and/or audible confirmation that the tiltrotor aircraft 100 is grounded.

Next, at block 310, the method 300 may prompt a user for a passcode as a condition precedent to entering the simulation mode of operation of the tiltrotor aircraft 100. Once a user enters a suitable passcode or is otherwise authenticated, the method 300 may continue to block 312. At block 312, the method 300 may conduct a lockout procedure in which one or more tiltrotor aircraft 100 operations is prevented until the simulation mode is exited. For example, upon entry into the simulation mode, the CSS 200 may prevent operation of engines, actuators 124, weapons, and/or any other system, component, and/or device of the tiltrotor aircraft 100. Still further, the method 300 may continue to block 314 by generating and outputting a simulated output, such as, but not limited to, an instrument reading, a tactile feedback, an audible feedback, a visual feedback, and/or flight simulation video. The simulated output can be accomplished using any of the normally existing components of tiltrotor aircraft 100, such as the displays 202, input devices 204, instruments 206, and controls 208.

Additionally, and/or alternatively, the simulated output can be accomplished using a dedicated simulation display 218. In some cases, a banner display may be provided across a display 202 of the CSS 200 indicating that a training and/or simulation mode is active. Subsequently, the banner may be removed and a display 202 may be bordered by a colored section that is known to a user to mean that the CSS 200 is operating in training and/or simulation mode. In some embodiments, a passcode and/or other authentication may be required to remove the CSS 200 from the simulation mode and return to a flight mode where a user can perform flight related functions using the same interfaces previously used for the training and/or simulation mode.

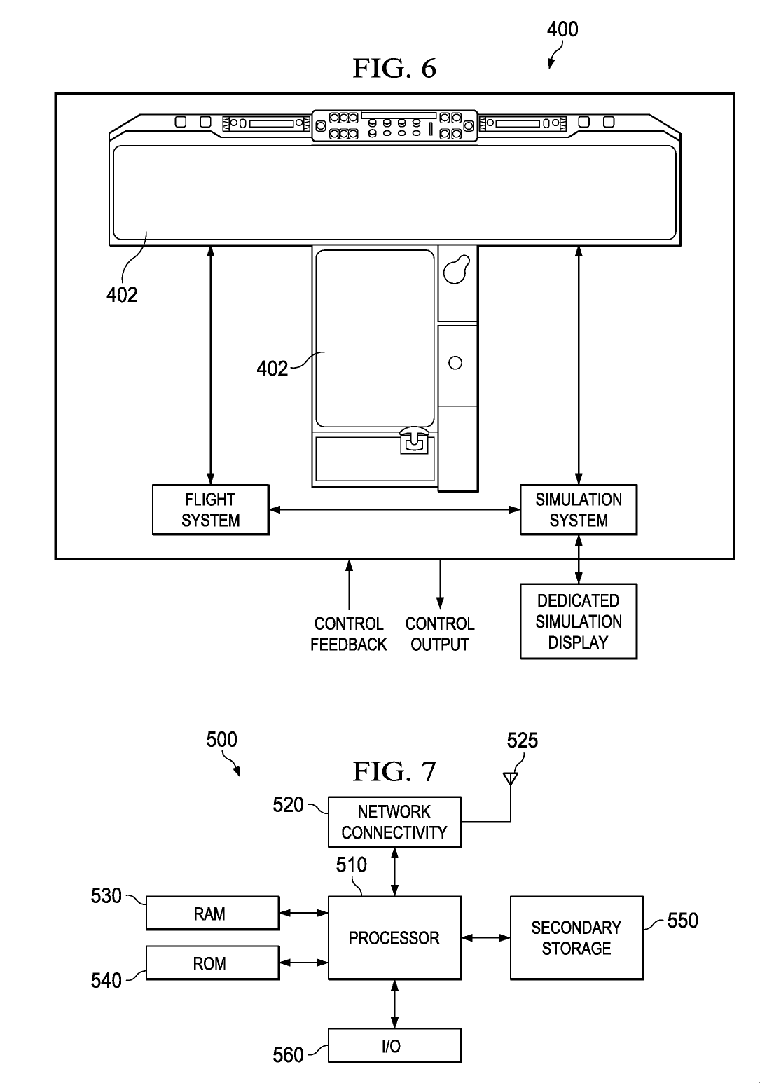

FIG. 6 shows an alternative embodiment of a CSS 400 that is substantially similar to CSS 200 but comprises a plurality of touchscreen devices 402 that can replace the functionality of one or more of the displays 202, input devices 204, instruments 206, controls 208, and/or dedicated simulation displays 218.

While the CSSs 200, 400 are described above with respect to being used in a tiltrotor aircraft 100, it will be appreciated that the functionality of the CSSs 200, 400 can be similarly applied to other vehicles and/or machines so that the vehicles and/or machines can be selectively placed in a training and/or simulation mode that locks out and/or prevents some normal functionality of the vehicles and/or machines. More specifically, in alternative embodiments, the CSSs 200, 400 can be utilized and/or incorporated with other aircraft, such as, but not limited to, helicopters, airplanes, dirigibles, and/or any other suitable aircraft. Still further, the CSSs 200, 400 can be utilized and/or incorporated into ground-based systems that cannot achieve flight but nonetheless comprise one or more aircraft components and/or a simulated existence of aircraft components.

FIG. 7 illustrates a typical, general-purpose processor (e.g., electronic controller or computer) system 500 that includes a processing component 510 suitable for implementing one or more embodiments disclosed herein. In particular, the CSSs 200, 400 and/or one or more of the above-described components of the CSSs 200, 400 may comprise one or more systems 500. In addition to the processor 510 (which may be referred to as a central processor unit or CPU), the system 500 might include network connectivity devices 520, random access memory (RAM) 530, read only memory (ROM) 540, secondary storage 550, and input/output (I/O) devices 560. In some cases, some of these components may not be present or may be combined in various combinations with one another or with other components not shown. These components might be located in a single physical entity or in more than one physical entity. Any actions described herein as being taken by the processor 510 might be taken by the processor 510 alone or by the processor 510 in conjunction with one or more components shown or not shown in the drawing. It will be appreciated that the data described herein can be stored in memory and/or in one or more databases.

The processor 510 executes instructions, codes, computer programs, or scripts that it might access from the network connectivity devices 520, RAM 530, ROM 540, or secondary storage 550 (which might include various disk-based systems such as hard disk, floppy disk, optical disk, or other drive). While only one processor 510 is shown, multiple processors may be present. Thus, while instructions may be discussed as being executed by a processor, the instructions may be executed simultaneously, serially, or otherwise by one or multiple processors. The processor 510 may be implemented as one or more CPU chips.

The network connectivity devices 520 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 520 may enable the processor 510 to communicate with the Internet or one or more telecommunications networks or other networks from which the processor 510 might receive information or to which the processor 510 might output information.

The network connectivity devices 520 might also include one or more transceiver components 525 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 525 might include separate receiving and transmitting units or a single transceiver. Information transmitted or received by the transceiver 525 may include data that has been processed by the processor 510 or instructions that are to be executed by processor 510. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 530 might be used to store volatile data and perhaps to store instructions that are executed by the processor 510. The ROM 540 is a non-volatile memory device that typically has a smaller memory capacity than the memory capacity of the secondary storage 550. ROM 540 might be used to store instructions and perhaps data that are read during execution of the instructions. Access to both RAM 530 and ROM 540 is typically faster than to secondary storage 550. The secondary storage 550 is typically comprised of one or more disk drives or tape drives and might be used for non-volatile storage of data or as an over-flow data storage device if RAM 530 is not large enough to hold all working data. Secondary storage 550 may be used to store programs or instructions that are loaded into RAM 530 when such programs are selected for execution or information is needed.

The I/O devices 560 may include liquid crystal displays (LCDs), touch screen displays, keyboards, keypads, switches, dials, mice, track balls, voice recognizers, card readers, paper tape readers, printers, video monitors, transducers, sensors, or other well-known input or output devices. Also, the transceiver 525 might be considered to be a component of the I/O devices 560 instead of or in addition to being a component of the network connectivity devices 520. Some or all of the I/O devices 560 may be substantially similar to various components disclosed herein.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A control and simulation system (CSS), comprising:
a flight system configured to selectively provide flight mode of operation of an aircraft; and
a simulation system configured to selectively provide a simulation mode of operating the aircraft.

2. The CSS of claim 1, wherein the aircraft must be grounded prior to entering the simulation mode.

3. The CSS of claim 1, wherein the CSS is configured to poll a status of a weight on wheels sensor.

4. The CSS of claim 1, wherein the CSS is configured to determine whether an auxiliary ground power unit is connected to the aircraft.

5. The CSS of claim 1, wherein the CSS requires a passcode authentication prior to entering the simulation mode.

6. The CSS of claim 1, wherein at least one functionality of the aircraft in the flight mode is prevented from being utilized during operation of the aircraft in the simulation mode.

7. The CSS of claim 1, wherein the CSS is a ground-based system.

8. The CSS of claim 7, wherein the aircraft is simulated.

9. The CSS of claim 7, wherein the aircraft is configured so as not to be able to achieve flight.

10. An aircraft, comprising:
a control and simulation system (CSS), comprising:
a flight system configured to selectively provide flight mode of operation of the aircraft; and
a simulation system configured to selectively provide a simulation mode of operating the aircraft.

11. The aircraft of claim 10, wherein the aircraft must be grounded prior to entering the simulation mode.

12. The aircraft of claim 10, wherein the CSS is configured to poll a status of a weight on wheels sensor.

13. The aircraft of claim 10, wherein the CSS is configured to determine whether an auxiliary ground power unit is connected to the aircraft.

14. The aircraft of claim 10, wherein the CSS requires a passcode authentication prior to entering the simulation mode.

15. The aircraft of claim 10, wherein at least one functionality of the aircraft in the flight mode is prevented from being utilized during operation of the aircraft in the simulation mode.

16. The aircraft of claim 10, wherein the aircraft comprises a helicopter.

17. The aircraft of claim 10, wherein the aircraft comprises a tiltrotor aircraft.

18. The aircraft of claim 10, wherein the aircraft comprises an airplane.
